(19) United States
(12) Patent Application Publication
(10) Pub. No.: US 2025/0256380 A1
(43) Pub. Date: Aug. 14, 2025

(54) BICYCLE STEERING ALIGNMENT SYSTEMS AND METHODS

(71) Applicant: Thomas McDaniel, Golden, CO (US)

(72) Inventor: Thomas McDaniel, Golden, CO (US)

(21) Appl. No.: 19/052,013

(22) Filed: Feb. 12, 2025

Related U.S. Application Data
(60) Provisional application No. 63/552,479, filed on Feb. 12, 2024.

(51) Int. Cl. B25B 27/00

(52) U.S. Cl. CPC B25B 27/0071

(57) ABSTRACT

Bicycle steering alignment systems and methods are disclosed herein.

### CROSS-REFERENCES TO RELATED APPLICATIONS

This application claims the benefit of U.S. Provisional Patent Application No. 63/552,479 filed Feb. 12, 2024, the disclosure of which is incorporated herein by reference.

### BACKGROUND OF THE INVENTION

Bicyclists aim to have the handlebar in perpendicular alignment to the front wheel. The fork and stem interface is round, making alignment difficult to achieve. This can be an annoyance and for some riders an endless pursuit. To date, several tools on the market offer handlebar alignment, by way of a stem-mounted apparatus that aims a laser at the front tire. However, there are multiple fundamental errors resulting from this method. Additionally, the current trends in the equipment of modern bicycles are making them obsolete. Furthermore, these tools present alignment solutions exclusively for the handlebar. Hence, there continued to be a need for new and improved bicycle steering alignment systems and methods. Embodiments of the instant invention address at least some of these outstanding needs.

### BRIEF SUMMARY OF THE INVENTION

Exemplary bicycle steering alignment systems and methods disclosed herein operate by leveraging the frame dropouts and fork axles, which offer absolute alignment, and offer bespoke solutions that apply to every bicycle, regardless of the age or style of the bike. Use of these embodiments require very little understanding of the technical aspects of bicycle mechanics, making it friendly to all riders. Implementation of systems and methods disclosed herein can take users less than 2 minutes and require no additional tools.

### BRIEF DESCRIPTION OF THE DRAWINGS

FIGS. 1 to 16 depict aspects of bicycle steering alignment systems and methods, according to embodiments of the present invention.

### DETAILED DESCRIPTION OF THE INVENTION

All illustrations of the drawings are to be describing selected embodiments of the present invention and are not intended to limit the scope of the present invention. All references of user or users encompass either individual or individuals who would utilize embodiments of the present invention.

Steering alignment system and method embodiments of the present invention are well suited for use with a variety of bicycle types, including without limitation mountain bikes, road bikes, gravel bikes, commute bikes, fitness bikes, velodrome/track bikes, electric bikes, children's bikes, cargo bikes, and the like. In exemplary embodiments, steering alignment systems and methods disclosed herein can be used with any bicycle having a suspension or rigid fork.

Users of steering alignment systems and methods disclosed herein can include any of a variety of individuals or customers, including cyclists, mechanics, bike fitters, and frame manufacturers, as well as bike assemblers engaging in new bike builds, new stem installs, new handlebar installs, new fork installs, headset service, handlebar inspection/service, suspension fork service, post-crash inspections, full-suspension frame alignment inspections, and the like.

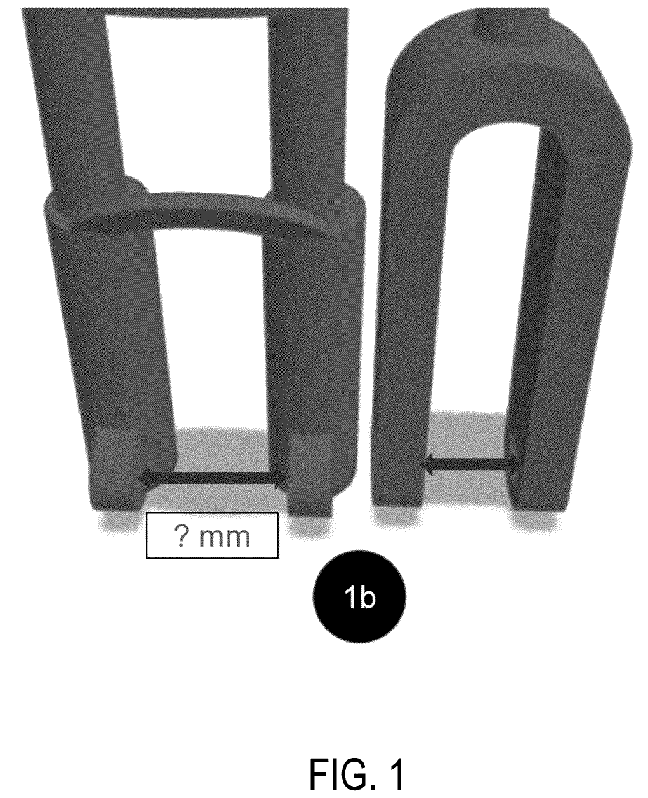

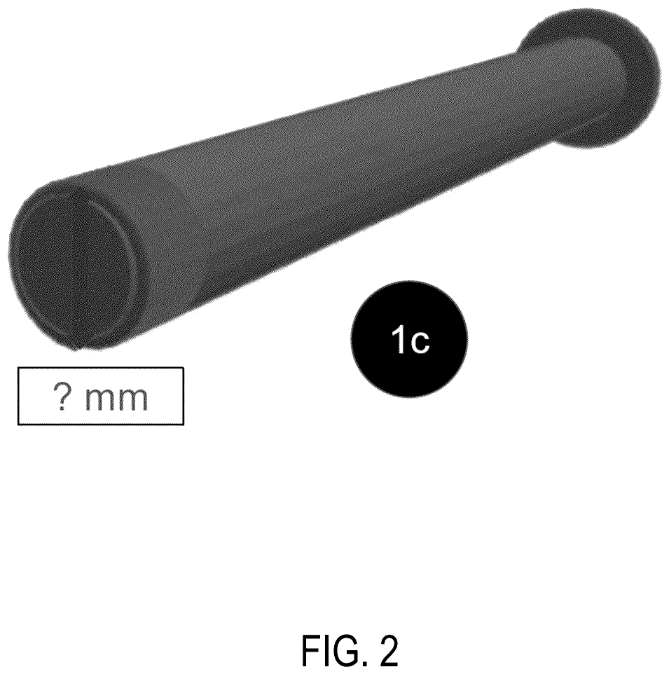

As an initial step, a user can identify aspects of the bicycle axle standard, as illustrated in FIGS. 1 and 2. For example, the axle style may be a thru axle, a quick release, or a bolt-on. The user can identify the dropout (hub) width (e.g. 100 mm, 110 mm, 130 mm, 135 mm, 142 mm, 148 mm, or 156 mm) as shown in step 1b. Likewise, the user can identify the axle diameter (e.g. 5 mm, 9 mm, 12 mm, 15 mm, or 20 mm) as shown in step 1c.

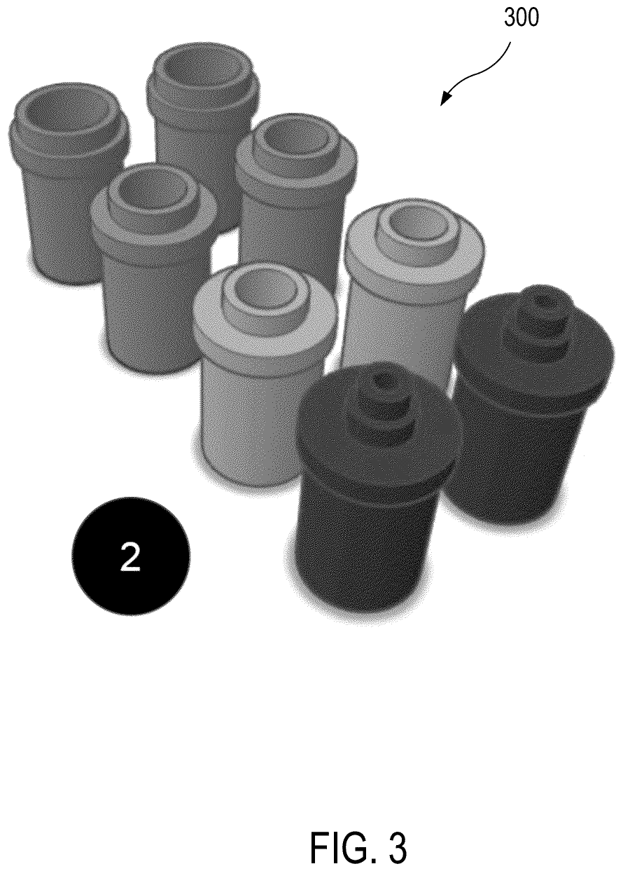

As shown in FIG. 3, the user can select the proper axle diameter adapter 300.

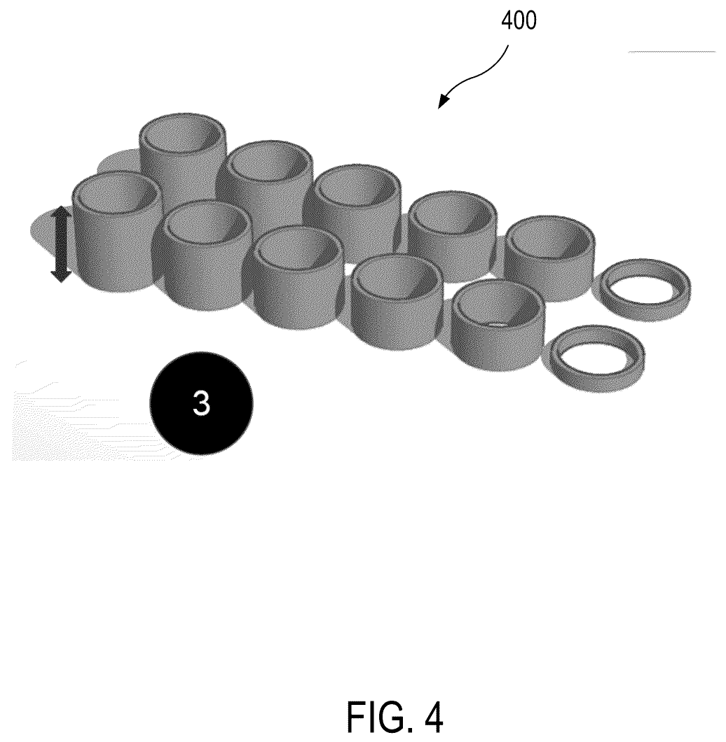

As shown in FIG. 4, the user can select dropout width spacers 400.

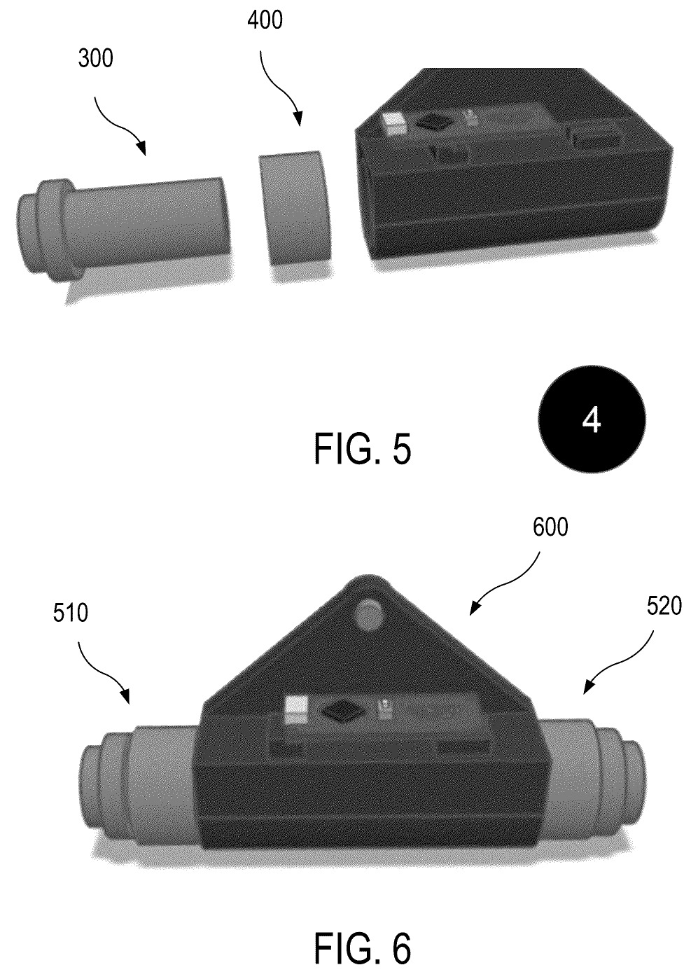

As shown in FIG. 5, the user can install the axle diameter adapters 300 on the dropout width spacers 400.

As shown in FIG. 6, one axle diameter adapter and dropout width spacer pair 510 can be inserted on one side of the alignment tool 600, and another axle diameter adapter and dropout width spacer pair 520 can be inserted on the other side of the alignment tool 600.

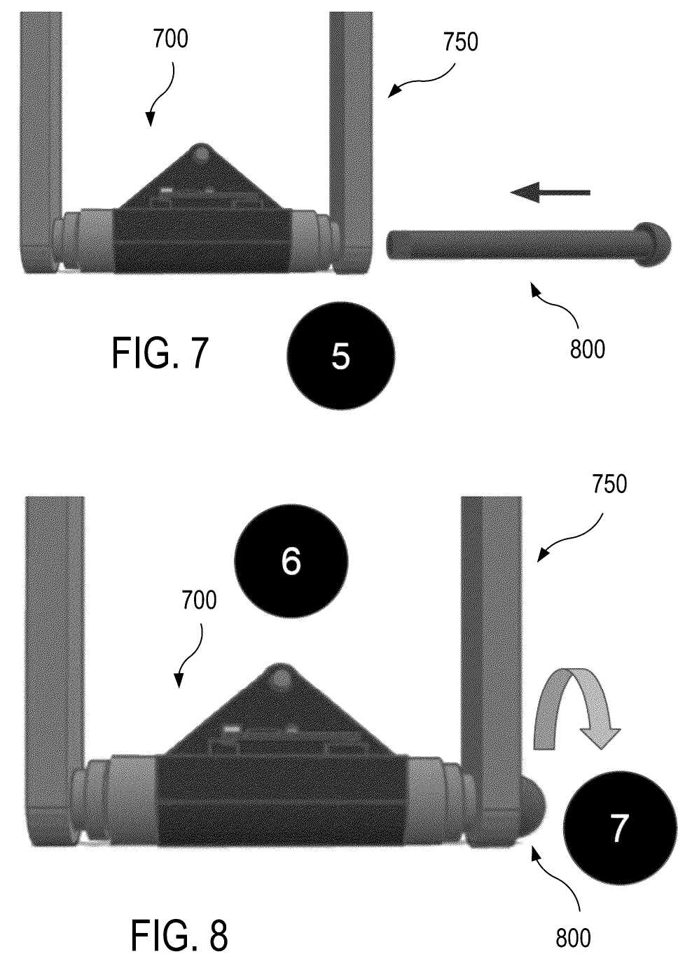

As shown in FIG. 7, the alignment tool (with adapter and spacer) assembly 700 can be inserted into the fork or frame dropout 750 of the bicycle, and the bicycle axle 800 can be inserted through the fork/frame 750 and alignment tool assembly 700.

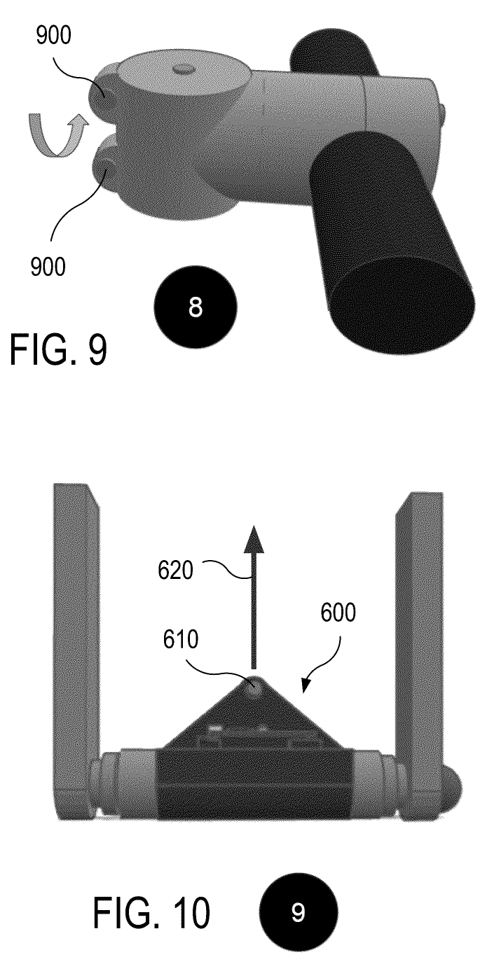

As shown in FIG. 8, the user can gently secure the axle or quick release with the bicycle fork/frame (e.g. <1 Nm of force).

As shown in FIG. 9, the user can loosen the stem steerer tube bolts 900.

As shown in FIG. 10, the user can turn on the alignment light 610 of the alignment tool 600, to produce an alignment light beam 620.

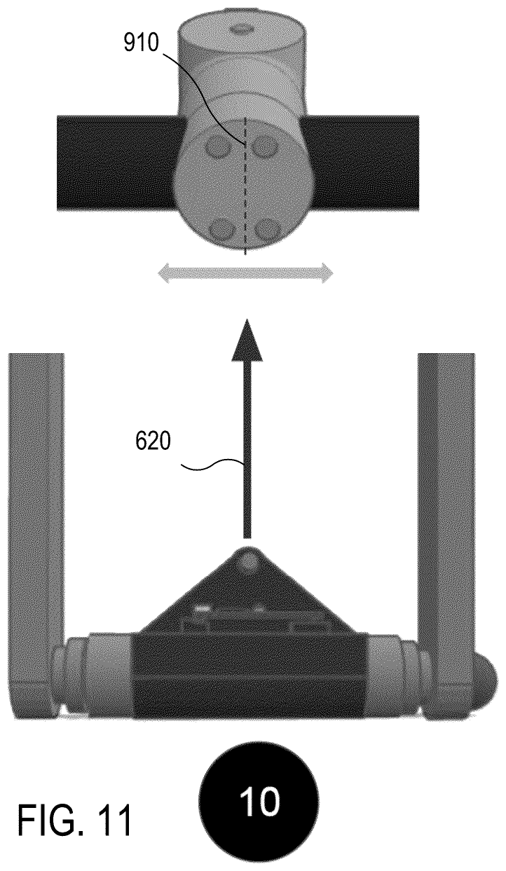

As shown in FIG. 11, the user can adjust the stem center 910 to align with the alignment light beam 620.

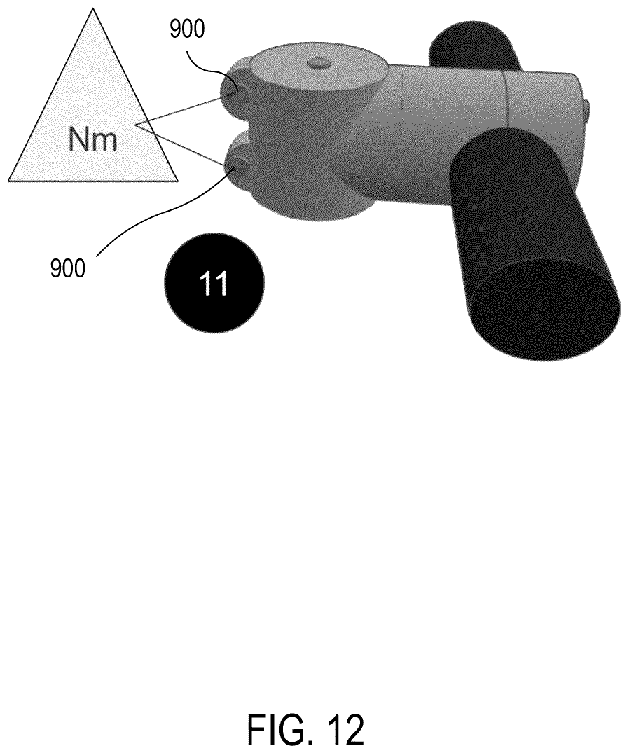

As shown in FIG. 12, the user can secure the steerer tube stem bolts 900 (e.g. to the proper/manufacturer's torque specification), thereby ensuring that the handlebar will remain in a desired alignment (e.g. perpendicular) with respect to the bicycle wheel.

In some embodiments, systems and methods provide alignment solutions for any of the axle standards included in Table 1 below.

TABLE 1

| Axle Standard | Axle Diameter (mm) | Axle Length (mm) |
|---|---|---|
| Quick Release (QR) | 9 (5) | 100/110/130/135/142 |
| Thru Axle | 12 | 100/110/135/142/148/157 |
| | 15 | 100/110 |
| | 20 | 110 |

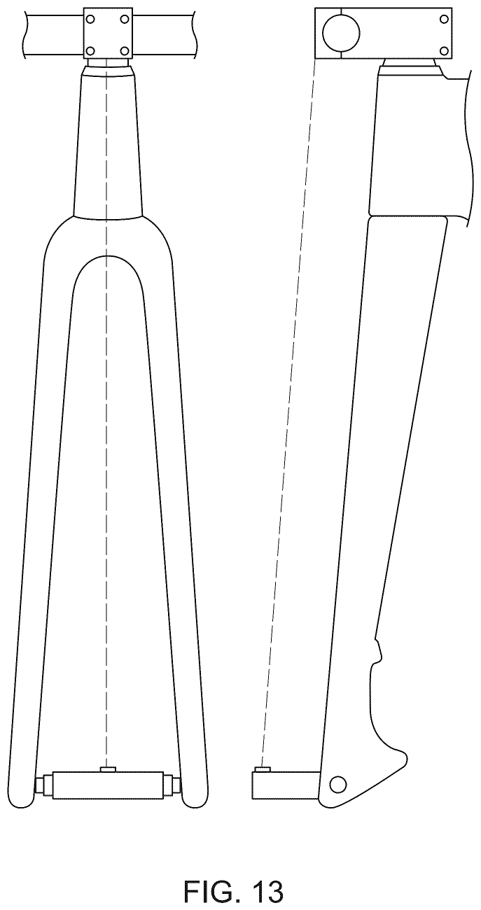

FIG. 13 depicts aspects of bicycle steering alignment systems and methods, according to embodiments of the present invention.

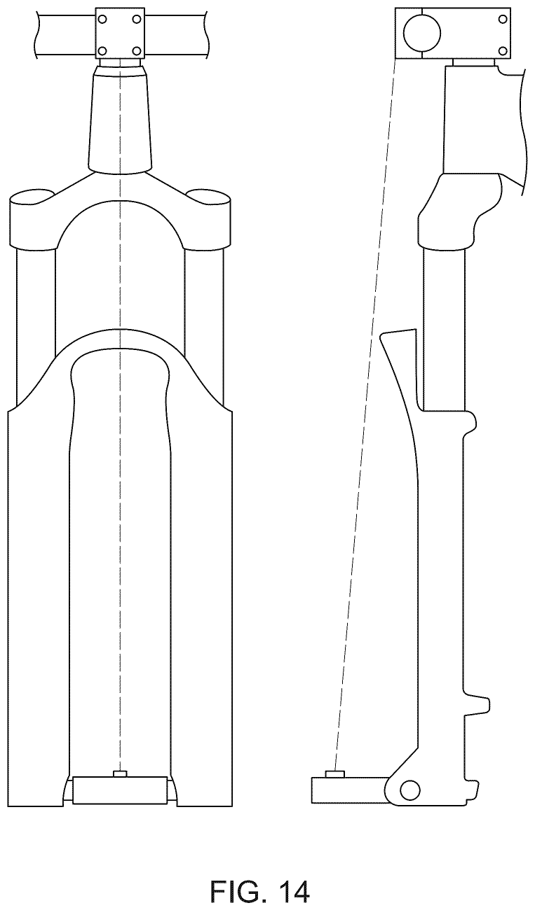

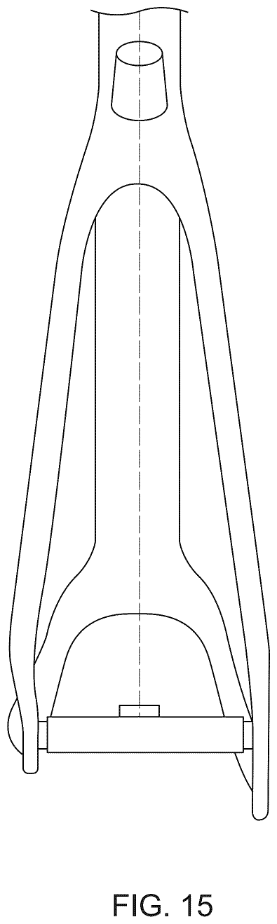

FIG. 14 depicts aspects of bicycle steering alignment systems and methods, according to embodiments of the present invention.

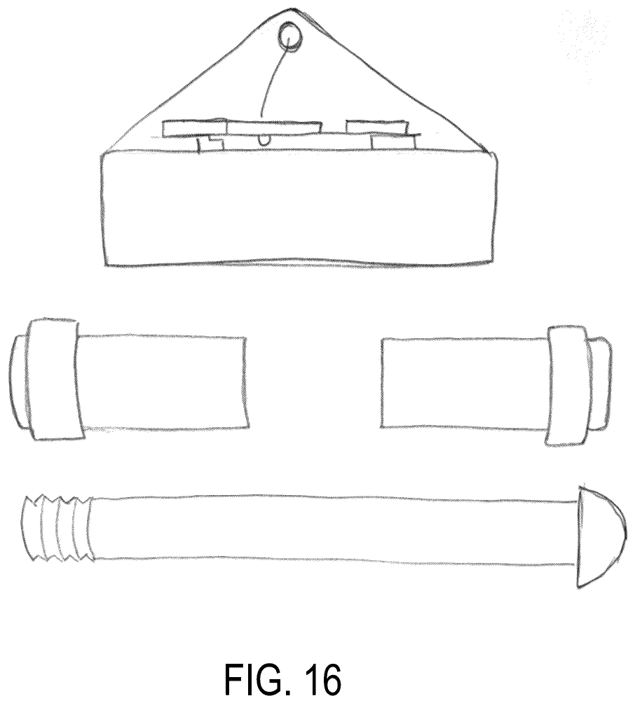

FIG. 15 depicts aspects of bicycle steering alignment systems and methods, according to embodiments of the present invention.

FIG. 16 depicts aspects of bicycle steering alignment systems and methods, according to embodiments of the present invention.

Exemplary alignment systems and methods disclosed herein use the frame dropouts and fork axles for achieving alignment. In some embodiments, alignment systems and methods disclosed herein make use of the interface of the wheel axle and frame dropout/interface during the alignment process. In some embodiments, alignment systems and methods disclosed herein make use of a thru axle during the alignment process. In some embodiments, alignment systems and methods disclosed herein make use of a quick release during the alignment process. In some embodiments, alignment systems and methods disclosed herein make use of a bolt-on element during the alignment process. In some embodiments, alignment systems and methods disclosed herein make use of a rigid fork during the alignment process. In some embodiments, alignment systems and methods disclosed herein make use of a suspension fork during the alignment process.

All features of the described systems and devices are applicable to the described methods mutatis mutandis, and vice versa. Embodiments of the present invention encompass kits having bicycle steering alignment systems as disclosed herein. In some embodiments, the kit includes one or more systems for bicycle steering alignment, along with instructions for using the system for example according to any of the methods disclosed herein.

Each reference provided herein in incorporated by reference in its entirety to the same extent as if each reference were individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

Although embodiments of the present invention have been explained in relation to one or more preferred embodiments, it is to be understood that many other possible modifications and variations can be made without departing from the spirit and scope of the invention.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

In this detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components. It is intended that the following claims define the scope of the invention and that methods and structures within the scope of these claims and their equivalents be covered thereby.

What is claimed is:

1. A bicycle steering alignment system or method as disclosed herein.

2. A bicycle steering alignment system.

3. A bicycle steering alignment method.
